(19) United States
(12) Patent Application Publication
(10) Pub. No.: US 2014/0202396 A1
(43) Pub. Date: Jul. 24, 2014

(54) TRIADIC SPINNING PET PUZZLE TOY WITH TREAT RECEPTACLES

(71) Applicant: Kyle Hansen, Castle Rock, CO (US)

(72) Inventor: Kyle Hansen, Castle Rock, CO (US)

(21) Appl. No.: 13/745,847

(22) Filed: Jan. 20, 2013

(51) Int. Cl. A01K 15/02

(52) U.S. Cl. CPC A01K 15/025
USPC 119/710

(57) ABSTRACT

The invention relates to a novel pet toy wherein the pet must determine how to solve the puzzle and obtain treats located in concealed receptacles in the base portion of the toy. The top portion must be rotated by the animal in such a way as to be off-center and remove barriers to the treat receptacles located in the base portion of the toy. Hinged coverings are located atop the receptacles so that even after the pet has rotated the top portion, it must then determine how to open the flaps and retrieve the treat.

### FIELD

The invention relates to a novel pet toy in which treats are located in receptacles wherein retrieval may be prevented or allowed when the animal is required to rotate the top triadic portion of the toy to reveal the treat receptacles.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel triadic puzzle wherein treats are inserted into receptacles and a pet must “solve” the puzzle to obtain the treat.

There are obviously many pet toys on the market. The inventive toy seeks to exercise a pet's sensory and problem solving skills as well as providing reinforcement or reward. The inventive toy is also very durable which offers purchasing incentive in a genre where purchasing decisions are often based upon cost versus life of the product.

### THE INVENTION

### Summary, Objects and Advantages

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

In the inventive toy, there are three branches in the base portion, and each contains a receptacle wherein treats may be deposited. Hinged flaps then cover those receptacles. Each flap has a scent opening for greater enticement and discoverability of the treat for the dog.

Affixed in the top center of the toy is a spinning or rotating tri-branched casing which will spin to either block the opening of the aforementioned flaps or will reside in the center point between two branches to allow retrieval of the treat via clearance for opening of the flap. The toy may be made more or less difficult to solve with the aid of a tightening knob located underneath the toy wherein adjustment may make the tri-armed casing harder to turn. This functions to enable smaller or larger dogs to use the toy depending upon their size and obvious strength variations.

A dog must engage its sensory skills and reasoning as it tries to find the source of the enticing smell. The act of having to “find” and recover the treat promotes maintaining healthy concentration, memory, and mental alertness.

Whether chasing a ball in the yard or using canine treadmills, exercise or play is vital in helping dogs expend pent-up energy. Without that outlet they may show behavioral problems that can range from destructive tendencies to attention-seeking antics. Especially dogs that live in a home where they are left alone for long periods of time. The inventive toy seeks to alleviate some of these issues as it can take a dog some time to find and navigate the puzzle toy to attain all the treats inserted.

### BRIEF DESCRIPTION OF THE DRAWINGS

The invention is described in further detail by reference to four drawings sufficient in detail to describe the invention in which:

FIG. 1 is a top perspective of the toy with one flap slightly ajar and the tri-branch casing is center point aligned with the flaps;

FIG. 2 is a top view with all flaps closed and the tri-branch casing atop the receptacle portions;

FIG. 3 is a side angle perspective showing one flap open and exposing the treat receptacle; and

FIG. 4 is a bottom view of the toy showing the tightening knob;

### DETAILED DESCRIPTION, INCLUDING BEST MODES OF CARRYING OUT THE INVENTION

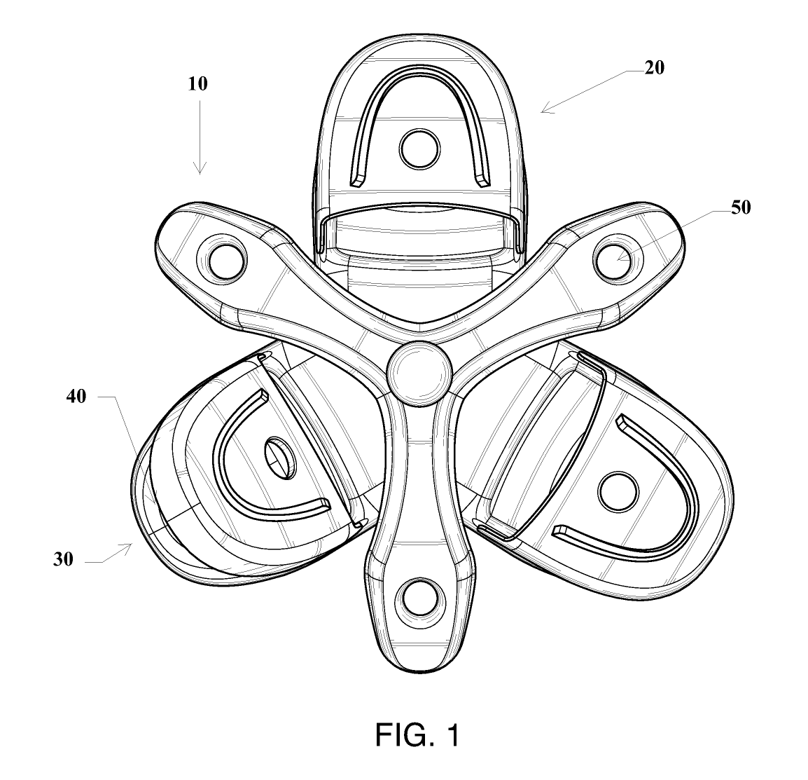

FIG. 1 is shows the puzzle toy with the tri-branch casing 10 rotated to allow access to the base piece 20. Once the animal determines how to nudge the top portion at an off-center point with the base it can then access the base flaps 30 and attempt to open them to retrieve the treat located in the receptacle 40. Scent holes 50 are located at each flap and on the top triadic spinning portion to aid in enticement of the animal.

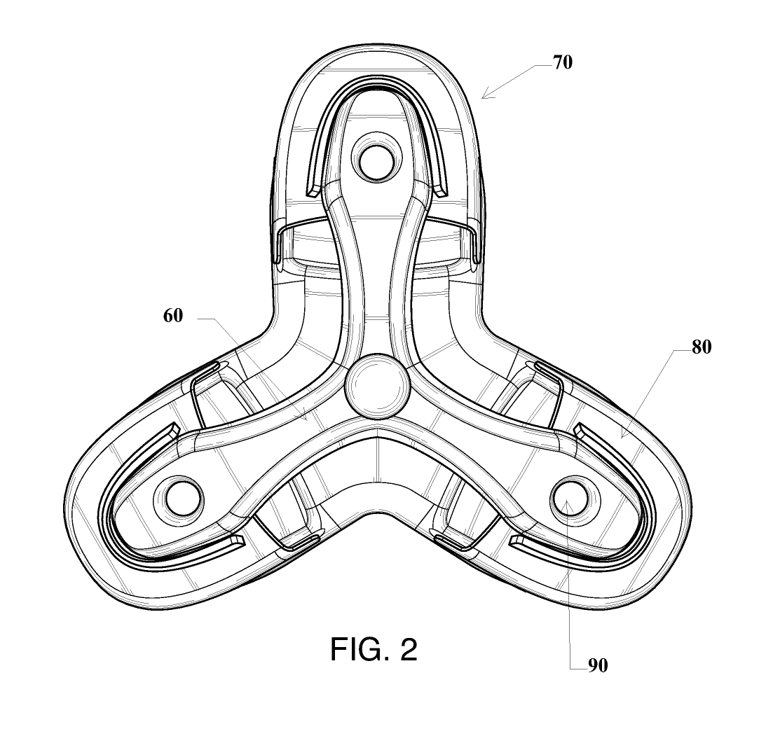

FIG. 2 illustrates the toy as in its home state wherein the rotating top piece 60 is settled into the base piece 70, and thus obscures the flaps 80. The scent holes 90 are still unencumbered so that the animal smells the treats and is enticed to attempt to solve the puzzle and acquire the treat or treats depending on how many receptacles the owner wishes to insert.

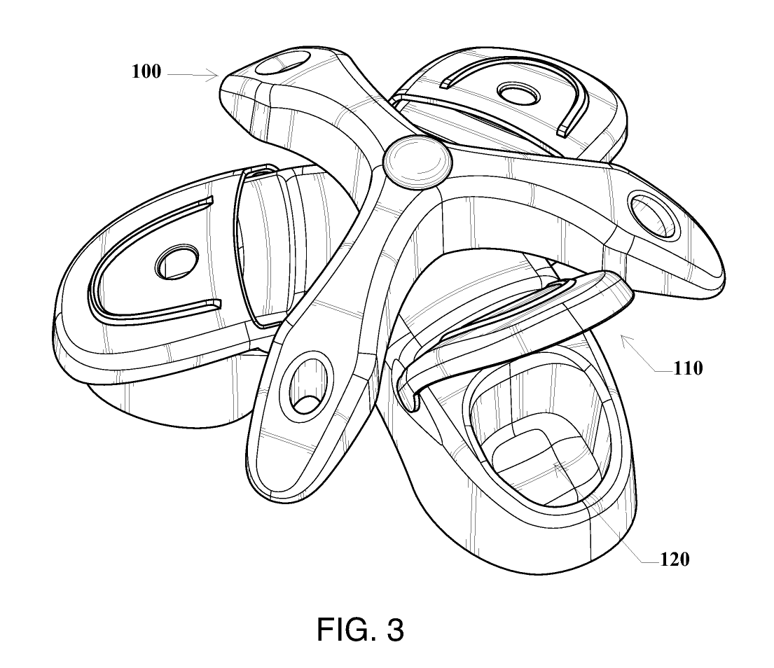

FIG. 3 shows the top spinning portion 100 off-center point so that the receptacle flap 110 is open and the treat receptacle 120 is visible. The animal must spin the top triadic piece to gain access to the receptacle flaps and thus the treat within the receptacle. An owner may increase the problem solving requirements of the animal by only placing a treat in one receptacle.

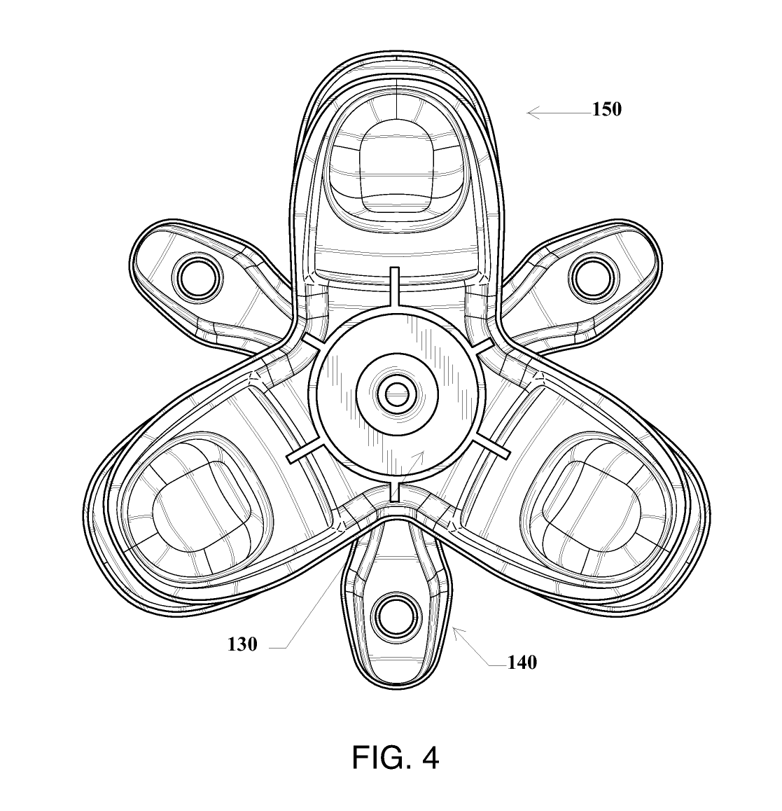

FIG. 4 is a bottom view of the toy showing the center knob 130 which serves as an axis point for the top spinning tri-branch piece 140 as affixed to the base 150 as well as a means to tighten the spinning action to accommodate larger (stronger) and smaller (weaker) animals.

1. A triadic spinning pet puzzle toy with treat receptacles comprising;
a) a tri-armed rotatable top portion
b) a base piece
c) covering flaps for said base piece
d) receptacles for treat containment
e) an axis point and knob for tightening or loosening said tri-arm top portion

2. A pet puzzle toy as in claim 1 wherein the top portion comprises a tri-branched piece which will rotate to cover or uncover the base piece covering flaps.

3. A pet puzzle toy as in claim 1 wherein the base piece has hinged covering flaps that may be lifted open when unimpeded by the top tri-armed piece.

4. A pet puzzle toy as in claim 1 wherein the base piece has indented receptacles for placing treats therein.

5. A pet puzzle toy as in claim 1 wherein a center shaft creates an axis upon which the top rotatable portion may spin.

6. A pet puzzle toy as in claim 1 wherein a tightening knob is located at the base portion of the axis point for increasing or decreasing force required to rotate the top tri-armed portion.
